(19) United States
(12) Patent Application Publication
(10) Pub. No.: US 2019/0220826 A1
(43) Pub. Date: Jul. 18, 2019

(54) SYSTEMS AND METHODS FOR RECORDING TIME

(71) Applicant: JOAN R & D PTY LTD, Malvern East, Victoria (AU)

(72) Inventors: Antonio DE PERIO, St. Kilda (AU); Nicholas HALLAM, Malvern East (AU); Edward THOMSON, Clifton Hill (AU); Michael RUHFUS, Dulwich Hill (AU)

(73) Assignee: Tiller Time Pty Ltd., Malvern East, Victoria (AU)

(21) Appl. No.: 16/306,862

(22) PCT Filed: Jun. 3, 2017
(86) PCT No.: PCT/AU2017/050541

§ 371 Date: Dec. 3, 2018

Related U.S. Application Data
(60) Provisional application No. 62/345,148, filed on Jun. 3, 2016.

(51) Int. Cl. G06Q 10/10; G06F 3/0485; G06F 3/0482; G06F 3/0488

(52) U.S. Cl. CPC G06Q 10/1091; G06F 3/0488; G06F 3/0482; G06F 3/0485

(57) ABSTRACT

The present invention provides a system for recording time expended on a matter, the system comprising: time recording actuation means, matter identifier selection means, and a processor-enabled device comprising: input means configured to accept data output from the time recording actuation means and the matter identifier selection means, electronic memory having stored therein a plurality of matter identifiers, and visual display means, the processor-enabled device configured to display at least a proportion of the stored plurality of matter identifiers on the visual display means as a selectable menu, wherein upon actuation of the time recording actuation means or the matter identifier selection means, the visual display means displays a means for selecting one of the stored plurality of matter identifiers on the visual display means, and the matter identifier is selectable by the matter identifier selection means.

### FIELD OF THE INVENTION

The present invention relates to electronic systems for recording time expended by a person on a matter, such as a task. The invention may find utility in commercial or non-commercial settings.

### BACKGROUND TO THE INVENTION

It is often necessary or at least desirable for an individual to account for how he spends his time over the course of the working day. For example, in many professions a client is billed according to the amount time spent on a matter. Thus, in legal, accounting and similar practices it is typical for a professional to keep a close track of time so that a client can be accurately charged. Historically, time was generally tracked manually with a simple paper time recording sheet or similar, onto which the professional wrote the time spent on a particular matter. A single time recording sheet may be used over the course of a day, with time spent on multiple matters being recorded as the day proceeds. Alternatively, the professional may have a single sheet for each matter on which he is currently working and select the appropriate sheet according to the matter.

The latter arrangement is typically more efficient, as there is no need to collate time for a single matter by reference to multiple time recording sheets. When billing for the matter (say, at the end of the month) the time recorded for the month is collated by reference to a single time sheet. In such arrangements, it is typically for a time sheet maintained in the physical file for the matter concerned. When the professional accesses the file to work on the matter, the time sheet is easily accessible.

Professional practice has moved away from the use of physical files in favour of so-called “paperless” files. In such systems, documents are created, retained and accessed electronically by a computer. The prior art discloses automatic electronic time recording means incorporated into such systems, typically configured such that recording commences when the professional accesses the electronic file on his computer, and ceases when the file is closed. These systems are considered state of the art at present given that the professional does not need to remember record time, and all billable time is charged.

However, a problem in automatic time recording systems is a lack of accuracy. Billable time may not require any access to the electronic file, and so time may not be recorded for some activities. For example, a client may telephone a professional with a general query on a matter that does not require review of the relevant file. Given that the files is not accessed, the time is not billed. As another example, a colleague may enter a professional's office to discuss a shared matter which again does not necessarily require file access. A professional may conduct internet research, and the file may only be accessed toward the end of the research when the professional saves relevant documents identified in the research into the electronic file. In such circumstances, the professional must remember to open the file to start automatic recording, or to otherwise record the time. Often, such need to record time is spontaneous and so the particular file must be located in the filing system, or the matter reference number obtained so as to otherwise record the time. These activities take time, and indeed detract from the exercise of efficiently using and billing time. Where many such interruptions requiring recording of time occur over the day, the professional is significantly burdened to accurately record the amount of time spent on each matter.

Another problem with automatic time recording is that a client may be billed excessively. For example, while reviewing an open file a professional may be distracted by a social visit by a colleague. Unless the professional closes the file before the social visit commences, the client may be unfairly billed for the time taken for the social interaction. Given the spontaneous nature of the social visit, the professional may neglect to close the file so as to cease time recording. Alternatively, the professional may elect not to close the file because of the time and effort required to do so, and then reopen the file.

Time recording is also an important activity in non-professional workplace settings. For example, a worker in a small business may be required to account for time across a range of activities such as attending to telephone enquiries, processing orders, packaging goods, and banking. In such circumstances, the worker may use a dedicated desktop office timer having start, pause and stop functions, and record time spent on a task using a spreadsheet application. The application may be configured to collate time recording data and present same in numeric or graphic output for review by a manager. A worker charged with performing multiple tasks in a business will typically be very short of time, and indeed the requirement to record time accurately may hamper his or her work performance.

Apart from any commercial applications, time recording may be used by an individual in order to account for his time outside of work. Many individuals struggle to balance activities such as travel (to and from a place of work, leisure, or education) housework, gardening, leisure activities, cooking, shopping, child care and the like. Furthermore, in some families such tasks can be inequitably divided amongst members. Means for recording the time of an individual (or each individual in a family) will therefore be beneficial in private matters. At present, time recording by individuals may be carried out by making diary entries, notes (electronic or paper) with the results collated manually at the conclusion of a day, a week or a month. Of course, such approaches require diligence and significant effort on the part of the individual to faithfully record all time expended. Where many different tasks are undertaken in the course of a day, an unacceptable amount of time may be required in order properly record and collate time.

It is an aspect of the present invention to overcome a problem of the prior art by providing electronic systems and methods and methods for recording an individual's time over the course of a day, or a longer period. The present systems and methods may be superior in respect of any one or more of: ease of use, efficiency of use, accuracy of recording, or user appeal. It is a further aspect to provide an alternative to prior art systems and methods for time recording.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a system for recording time expended on a matter, the system comprising: time recording actuation means, matter identifier selection means, and a processor-enabled device comprising: input means configured to accept data output from the time recording actuation means and the matter identifier selection means, electronic memory having stored therein a plurality of matter identifiers, and visual display means, the processor-enabled device configured to display at least a proportion of the stored plurality of matter identifiers on the visual display means as a selectable menu, wherein upon actuation of the time recording actuation means or the matter identifier selection means, the visual display means displays means for selecting one of the stored plurality of matter identifiers on the visual display means, and the matter identifier is selectable by the matter identifier selection means.

In one embodiment of the system, the means of selecting one of the stored plurality of matter identifiers is a user-selectable menu, or a data entry window.

In one embodiment of the system, the time recording actuation means is a hardware device.

In one embodiment of the system, the matter identifier selection means is a hardware device.

In one embodiment of the system, the time recording actuation means and the matter identifier selection means is embodied as a single hardware device.

In one embodiment of the system, the single hardware device is a peripheral device with reference to the processor-enabled device.

In one embodiment of the system, the time recording actuation means comprises a hardware switch component.

In one embodiment of the system, the matter identifier selection means is configured to output a data value over a range of possible data values.

In one embodiment of the system, the matter identifier selection means is operable by a manual rotation motion, or a manual sliding motion.

In one embodiment of the system, the matter identifier selection means comprises a variable resistance component.

In one embodiment of the system, the single hardware device comprises a single user operable part configured to actuate both the time recording and also select a desired matter identifier from the plurality of stored matter identifiers.

In one embodiment of the system, the single user operable part hardware device is configured to allow actuation of time recording by depressing, and selection of a desired matter identifier from the plurality of stored matter identifiers by rotation.

In one embodiment the system further comprises wherein the time recording cessation means.

In one embodiment of the system, the time recording actuation means is configured to function also as the time recording cessation means.

In one embodiment of the system, the processor-enabled device comprises an operating system which supports the display of multiple windows on the visual display means, and dedicated software configured to accept input from the time recording actuation means and the matter identifier selection means, wherein upon actuation of the time recording actuation means, the dedicated software displays at least a proportion of the stored plurality of matter identifiers on the visual display means as a selectable menu in a manner immediately noticeable to a user.

In one embodiment of the system, the manner immediately noticeable to a user comprises display of the at least a proportion of the stored plurality of matter identifiers on the visual display means as a selectable menu so as not to be partially (or optionally completely) obscured by any other window displayed on the visual display means.

In a second aspect, the present invention provides a kit of parts comprising: a hardware device comprising time recording actuation means, and matter identifier selection means, and dedicated software executable by a processor-enabled device having visual display means, the processor enabled device capable of operable connection with the hardware device; or means to download such software, wherein the software is configured such that upon actuation of the time recording actuation means, the visual display means displays at least a proportion of the stored plurality of matter identifiers on the visual display means as a selectable menu, and the matter identifier is selectable by the matter identifier selection means.

In one embodiment of the kit, the time recording actuation means and the matter identifier selection means is embodied as a single hardware device.

In one embodiment of the kit, the hardware device is a peripheral device with reference to the processor-enabled device.

In one embodiment of the kit, the time recording actuation means comprises a hardware switch component.

In one embodiment of the kit, the matter identifier selection means is configured to output a data value over a range of possible data values.

In one embodiment of the kit, the matter identifier selection means is operable by a manual rotation motion, manual sliding motion.

In one embodiment of the kit, the matter identifier selection means comprises a variable resistance component.

In one embodiment of the kit, the single hardware device comprises a single user operable part configured to both actuate the time recording and select a desired matter identifier from the plurality of stored matter identifiers.

In one embodiment of the kit, the single user operable part hardware device is configured to allow actuation of time recording by depressing, and selection of a desired matter identifier from the plurality of stored matter identifiers by rotation.

In one embodiment, the kit further comprises wherein the time recording cessation means.

In one embodiment of the kit, the time recording actuation means is configured to function also as the time recording cessation means.

In one embodiment of the kit, the software is configured such that upon actuation of the time recording actuation means, the dedicated software displays at least a proportion of the stored plurality of matter identifiers on the visual display means as a selectable menu in a manner immediately noticeable to a user.

In one embodiment of the kit, the manner immediately noticeable to a user comprises display of the at least a proportion of the stored plurality of matter identifiers on the visual display means as a selectable menu so as not to be not partially (or optionally completely) obscured by any other window displayed on the visual display means.

In a third aspect, the present invention comprises software configured to be resident on the processor-enabled device and operable in the system of any one of claims 1 to 16, the software configured so as to allow a time recording actuation means of a device to function, and a matter identifier selection means to function in accordance with the system as described herein.

In a fourth aspect, the present invention provides a method for recording time expended on a matter, the method comprising the steps of providing the system as described herein, actuating the time recording actuation means, viewing the at least a proportion of the stored plurality of matter identifiers on the visual display, selecting a matter identifier using the matter identifier selection means, and optionally using the time recording cessation means (where present) to stop time recording.

In one embodiment, the method is devoid of the step of manipulating a window on the visual display means so as to allow so as to allow viewing of the at least a proportion of the stored plurality of matter identifiers.

### BRIEF DESCRIPTION OF THE DRAWING

FIG. 1 shows in diagrammatic form a highly preferred system of the present invention. The arrowed lines shows the path and direction of travel of signals and information throughout the system.

FIG. 2 shows in block diagram form a system of the present invention integrated with a legal firm case management system and database.

### DETAILED DESCRIPTION OF THE INVENTION AND PREFERRED EMBODIMENTS

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

It is not represented that all embodiments of the invention have all advantages described herein. Some embodiments may have only a single advantage, while other embodiments may have no advantage whatsoever and provide a useful alternative to the prior art.

The present invention is predicated at least in part on Applicant's finding that while a processor-based device (such as a personal computer, smart phone, tablet, phablet, laptop, notebook or the like) can improve the efficiency of time recording, the user interfaces of such devices (while essential to the operation of the device) in fact hamper the recording process. In particular, the presence of multiple open windows or other confounding graphical component on the user visual interface of a device protracts, makes difficult or otherwise complicates the identification of the matter for which the time is to be recorded against. Accordingly, in a first aspect the present invention provides a system for recording time expended on a matter, the system comprising: time recording actuation means, matter identifier selection means, and a processor-enabled device comprising: input means configured to accept data output from the time recording actuation means and the matter identifier selection means, electronic memory having stored therein a plurality of matter identifiers, and visual display means, the processor-enabled device configured to display at least a proportion of the stored plurality of matter identifiers on the visual display means as a selectable menu, wherein upon actuation of the time recording actuation means or the matter identifier selection means, the visual display means displays means for selecting one of the stored plurality of matter identifiers on the visual display means, and the matter identifier is selectable by the matter identifier selection means.

The present system may be implemented on a personal computer having software allowing for the electronic recordation of time. Actuation means are provided by the system to allow a user to deliberately start a count-up timer of the software. The system is configured such that before, during or after the time recording means is actuated, the user is permitted to select a matter identifier for which the time is being recorded (or for which the time is to be recorded). The selection is by way of a user-selectable menu which is displayed on the visual display means of the processor-enable device, and from which a matter identifier is selected by of user manipulation of matter identifier selection means.

The configuration of the system to display the means for selecting one of the stored plurality of matter identifiers allows for the user to rapidly access the plurality of matter identifiers potentially selectable against which time may be recorded. Thus, the user may be enabled to instantaneously select a matter identifier, and without the need to visually scan the visual display means. This ability to rapidly access the plurality of matter identifiers may be facilitated by system configuration to make the means for selecting one of the stored plurality of matter identifiers (such as the user-selectable menu) visually prominent, or more visually prominent on the visual display means. For example, the system may be configured so as to visually highlight the means for selecting one of the stored plurality of matter identifiers such as by presentation in a contrasting color (or a lack of color), or by flashing the means, rapidly and repeatedly moving the means a short distance from left to right on the visual display means, and the like.

In addition or alternatively to the above, the means for selecting one of the stored plurality of matters may be displayed so as to be on top of any one, most or all other visual elements present on the visual display means. As is understood by the skilled person, many operating systems allow for different applications, or different files within an application to be displayed as windows on a visual display means. Thus, a window may be hidden (partially or completely) by an overlying window and therefore difficult (or impossible) for the user to see without moving, resizing or minimizing at least one other window. Rather than be displayed so as to be on top of other visual elements, the system may be configured such that the other visual elements are automatically moved, resized, minimized, made at least partially transparent or made invisible so as to highlight the means for selecting one of the stored plurality of matter identifiers to the user.

In any event, the system may be configured such that the means for selecting one of the plurality of matters

Given the benefit of the present specification, the skilled person will be enabled to identify other strategies by which the means for selecting one of the stored plurality of matter identifiers may be brought to the immediate attention by the user thereby gaining advantage from the present invention.

Making the means for selecting one of the stored plurality of matter identifiers (such as the user-selectable menu) visually prominent, or more visually prominent on the visual display means may be triggered by a system input. Where the system comprises a dedicated separate hardware device (as described more fully infra) any switch, selector or other user input when triggered may make the means for selecting one of the stored plurality of matter identifiers visually prominent, or more visually prominent on the visual display means. In other embodiments, a user input to a computer of the system may make the means for selecting one of the stored plurality of matter identifiers visually prominent, or more visually prominent on the visual display means

Applicant proposes that the user saves considerable efficiencies are gained where the user is not required to spend time and effort searching for the means for selecting one of the stored plurality of matter identifiers on the visual display means. For example, the means for selecting one of the stored plurality of matter identifiers may be a graphical menu displayed as a window, and according to the present invention the system may be configured so as to display that window so as to be immediately obvious to the user.

The graphical menu may consist of a vertical list of matter identifiers, with the user able to scroll through the list so as to select the desired matter identifier. The system may be configured so as to order the list according to a user preference, and may be ordered alphabetically (according to client name, for example), numerically (according to client reference number, for example) or according to most recently accessed matter identifier. Fly-out menus may be provided such that selection of a client name of a menu triggers a fly-out menu listing all matters relevant to that client. The user may then select the matter at hand relatively quickly and easily.

In some embodiments, the means for selecting one of the stored plurality of matter identifiers comprises a graphical window having a data entry window to allow a user to search for a matter identifier. For example, a user may insert the first several letters of a client name into the data entry window with the system searching electronically among all stored matter identifiers to identify the relevant client (or possibly several potentially relevant clients).

Once the matter identifier is selected, the system attributes the time currently being recorded (or the time which is about to be recorded, or the time which has just been recorded) to the selected matter identifier. The matter identifier and recorded time may be stored on an electronic database of the system for later recall, or exported to an external database.

Typically, the system is configured so as to allow for entry or import of a plurality of matter identifiers in accordance with those from which the user may be required to select. As one example, where the system is configured for use in a legal practice the matter identifiers may be a reference which is unique for a discrete billable matter. The discrete billable matter may be a litigation matter, or a business sale agreement matter, or a trade mark application matter, just as several examples.

While the matter identifier may be a simple number (which may accord to a file number) it is preferable that the reference is immediately identifiable to the user. This allows for the user to very quickly select the relevant matter identifier. Thus, when a user receives a telephone enquiry from a client, the user may select from a list of client names on a menu. Once selected, the system may allow for the user to select from a sub-menu, a sub-identifier for the client such as a departmental name (e.g. human resources department, or marketing department) and even a third sub-menu such as a work category (e.g. litigation matter, or general enquiry).

The present system comprises a time recording actuation means which may be embodied in hardware form. The recording actuation means may be an existing component of the processor-enabled device, and is not therefore dedicated to that task. Typically, a simple positive input signal is required to start recordation of time.

Where the device is a computer or smart phone for example, the time recording actuation means may be a hardware touch screen which accepts user input in the form of a simple tap with a finger, or a more complex gesture by the user. As another possibility, the time recording actuation means may be a hardware microphone capable of detecting a spoken instruction from a user (e.g. “start recording”) or a hardware camera capable of detecting a hand movement or facial expression of a user. Other possible time recording actuation means are a keyboard button, a mouse button or other similar hardware existing on a computer or smartphone. In another embodiment the time recording actuation means is not associated with a computer or a smartphone and may be a dedicated actuation means such as a mechanical button or a touch switch such as a capacitance touch switch, a resistance touch switch or a piezo touch switch. Such switches are not mechanical in nature, and are therefore easy to operate and less susceptible to malfunction due to the lack of moving parts.

Preferably, the time recording actuation means is separate from the processor-enabled device in a physical sense, and optionally also a logical sense. It is proposed that the presence of a separate peripheral hardware device on the desk of a user facilitates time recording actuation. The user is not forced to remember a particular spoken command, key, or gesture; or to locate a graphical window on the visual display means in order to commence time recording. For example, as soon as a user answers a telephone call he/she actuates the separate hardware device so as to start recording. By this arrangement, time is very accurately recorded and more so compared with prior art recoding means.

Furthermore, the presence of a separate hardware device on a user's desk is proposed to provide a visual reminder to record time. To that end, the separate hardware device may be configured so as to reflect or emit light so as to catch the eye of a user more effectively. For example, at least part of the device may be fabricated from or coated in a reflective material (such as a metal, or a metallic paint), or comprise one or more light emitting diodes.

In one embodiment, the separate hardware device is not a mouse or is not a keyboard. Neither of these contrivances is visually distinctive, and so will not serve to visually prompt the user to record time.

In one embodiment, the separate hardware device is substantially devoid of moving parts, operating wholly or predominantly by user touch.

Further included in the scope of the present invention are embodiments where the rotary function (used for selecting a matter) is separate to the actuation means (used to record time). In such embodiments, the system may be considered to comprise two hardware components with both required to operate the time recording function of the system.

In any event, a mouse and keyboard perform other functions and so the user would be required to actuate these devices in a specific manner so as to be operable in the context of the present system so as to actuate time recording, or to cease time recording, or to select a matter identifier.

It is further preferred that the time recording actuation means is configured so as to function also as a time recording cessation means. Again, this facilitates time recordation because a single device is required so as to start and stop time recording. Very little mental effort is required on the part of the user to start and stop recording given that only a single means is used for both functions.

The time recording actuation means (which may also be a time recording cessation means) may be operable by way of a simple binary switch such that a first depression of the switch actuates time recording, and optionally a second depression ceases time recording.

Alternatively, a capacitive sensing system which responds to a user's touch may be implemented to start or stop time recording. In this embodiment, an upwardly facing surface of the hardware device is an electrical insulator and the other side is a conductive material. A small voltage is applied to the conductive material, resulting in a uniform electrostatic field. When a conductor, such as a human finger, touches the insulator, a capacitor is dynamically formed.

To even further facilitate time recording, the time recording actuation means (which may also be a time recording cessation means) may be configured so as to function also as a matter selection means. Thus, with a single separate hardware device the user is enable to start and stop time recording for a desired matter identifier. This provides distinct advantage given that the three tasks may be required to be executed rapidly by the user rapidly or where the user is otherwise distracted by a conversation.

In the context of a separate hardware device the matter identifier selection means may be configured so as to output a data value over a range of possible data values. This may be achieved by the incorporation of a hardware rotary selector or a hardware sliding selector into the separate hardware device so as to allow scrolling through or otherwise sequentially revealing multiple stored matter identifiers on the visual display means. A rotary or sliding potentiometer or rheostat of the type well known in the art may be useful in that regard. Such components are capable of substantially continuously variable output which may be decoded by software means into an upward and downward scrolling function so as to sequentially review matter identifiers in the context of a graphical menu.

In other embodiments, the matter identifier selection means may be configured so as to output only two data values with a first value being decoded by software to scroll upwardly and a second value being configured so as to scroll downwardly. In terms of useful hardware a basic three-positional switch may be incorporated into the separate device, whereby the switch automatically centres (no data output) and can be manipulated by the user to a first position (a first data value is output so as to result in upwards scrolling), and a second position (a second data value is output so as to result in downwards scrolling).

In one embodiment, the system is configured such that the time recording actuation means (which may also be a time recording cessation means) functions also as a matter identifier selection means and also a matter identifier entry means. By this arrangement, a user may use the device to firstly scroll through the plurality of stored matter identifiers (using the matter identifier selection means) and upon selecting the desired matter identifier (for example by scrolling the desired identifier to the centre of a graphical window), actuate the time recording actuation/cessation means to enter the selected matter into the system. Once entered, time recording is commenced by the user actuating the time recording actuation means and then stopping time recording using the same means.

In a highly preferred embodiment of the system, the separate hardware device is operable so as to provide time recording actuation, time recording cessation, matter identifier selection, and matter identifier entry by way of a single user-manipulable component. As an example of such a device, the device may comprise a rotary device such as a potentiometer having a centring function and an incorporated momentary normally open switch. The potentiometer and momentary switch disposed underneath of and are connected to a disc disposed horizontally. The switch is actuated (i.e. move from open to closed) by depressing the disc downwardly. The disc is biased to the upward position, and so upon release of the wheel by the user the switch reverts to the open position. The potentiometer is operated (i.e. to alter the variable output) by clockwise and counter-clockwise rotation of the disc. The user initially depresses the upper face of disc so as to actuate the momentary switch which in turn transmits a signal to the processor-enabled device by way of hardware interface (such as a universal serial bus port, or via Bluetooth™). The signal is received by the operating system and passed to dedicated software in the device. The dedicated software causes display of a menu graphical window on the visual display such that the window is not obscured by any other graphical element of the visual display. The menu comprises a display box showing at one time no more than ten matter identifiers as a vertical list. The user scrolls through the vertical list by rotating the disc clockwise and/or anti-clockwise causing transmission of a series of data values to the processor-enabled device, the values received by the operating system which passes the values to the dedicated software so as to cause scrolling of the identifiers in the menu. Scrolling is continued until the desired matter identifier is disposed at the top of the display box. The user depresses the disc downwardly so as to actuate the momentary switch which in turns transmits a signal to the processor-enabled device which passes the signal to the dedicated software which in turn causes entry of the desired matter identifier into a memory location of the device.

In some embodiments, the potentiometer is replaced with a rotary encoder, being an electro-mechanical device that converts the angular position or motion of a shaft to an analog or digital code. The rotary encoder may be absolute and incremental (relative). The output of absolute encoders indicates the current position of the shaft, making them angle transducers. The output of incremental encoders provides information about the motion of the shaft, which is typically further processed elsewhere into information such as speed, distance and position. A rotary encoders may be used in applications that require precise shaft unlimited rotation, such as may be required for the selection of an item from a menu.

The user again depresses the disc so as to cause actuation of the momentary switch with the signal from the momentary switch being transmitted to the processor-enabled device, and in turn to the dedicated software. The dedicated software recalls the immediately preceding entry of the desired matter identifier and commences recording of time against that matter. At the conclusion of the task, the user again depresses the disc so as to cause actuation of the momentary switch which in turn transmits a signal to the processor-enabled device. The dedicated software recognises that time is being recorded against the desired matter identifier and then ceases recording time. The recorded time is saved to memory of the processor-enable device, or another device for subsequent use by the user or another software component.

A capacitive sensing system as discussed supra may be further implemented as a system input which causes the means for selecting one of the stored plurality of matter identifiers (such as the user-selectable menu) to become visually prominent, or more visually prominent on the visual display means. This system input may be separate to the input provided by a binary switch or rotary selector or other user actuatable function. Advantageously, the user is able to touch the hardware device to simply move the user-selectable matter menu to the front of the operating system desktop, and with the user inadvertently also selecting a matter or starting/stopping time actuation.

As will be understood the separate system input is not necessarily a touch sensitive capacitive input of a separate hardware device, and indeed is not necessarily even reliant on the separate hardware device. For example, a voice command to a computer of the system may be sufficient to bring forward a matter selection window, with the hardware device then being used to select the matter (say, by means of a rotary selector) and start/stop time recording (say, by a binary switch).

As will be understood the separate system input is not necessarily a touch sensitive capacitive input of a separate hardware device, and indeed is not necessarily even reliant on the separate hardware device. For example, a voice command to a computer of the system may be sufficient to bring forward a matter selection window, with the hardware device then being used to select the matter (say, by means of a rotary selector) and start/stop time recording (say, by a binary switch).

Certain embodiments of the system may be configured to exchange information or to provide or receive inputs or outputs (by way of an API, for example) with or to or from a matter management system and/or time management system, and particularly that or those of a third party. An example of a third party matter management system (with incorporated time management) is a legal practice case management system. Such case management systems are configured to allow for staff of the practice to select a case on a menu (for example, a litigation case) and record billable time in respect the selected matter. In the context of the present invention, the case management system and/or the present system may be configured such that a matter selected by the present system is passed to the case management system, and time recorded by the present system is passed to the case management system.

The present system and/or the case management system may be configured such that the present system extracts or otherwise has access to a plurality of cases handled by the legal firm, with the cases being selectable by a menu of the present system. The present system may have access to a relational database of the case management system, or may access database records via the case management software. Other user-selectable parameters of the case management system may be accessible by the present system such as fee earner identification, practice group identification, work category identification, and the like.

The time recording actuation means and the time recording cessation means of the present system (however embodied) may further provide inputs to the case management software so as to allow native recording of time within the case management system. Alternatively, the present system may record an elapsed time, and then pass that information to the case management system software.

In some embodiments, the present system is configured to interface with a cloud-based time recording service such as Timely™ (Timely AS, Norway). Timely™ requires a user to select from parameters such as user, activity, phase, project, client and the like. The required user, activity, phase, or project is then selected by the user. The present system may be configured to allow for user identification, activity identification, phase identification or project identification (just to name several examples) to be selected by the present system, and for time to be recorded against each parameter.

Timely™ API may facilitate integration with the present system. API documentation for Timely™ may be obtained from Timely AS, Norway or via the URL: https://dev.timelyapp.com/v1.

The present system may comprise software means to extract information and report on the time recorded according to any one or more of matter, employee, work type, billable/non-billable work, client, date, and the like. Algorithms in software of the present system may be provided to process and analyse raw time recorded and present useful information in the form of tables, charts, graphs, lists and the like. By such embodiments, a manger may be enabled to review how a certain employee spends his or her working day, or how much litigation work a technology group has carried out in the last month. Alternatively, a software business is enabled to be informed which clients occupy most of his/or her time in the course of a quarter year.

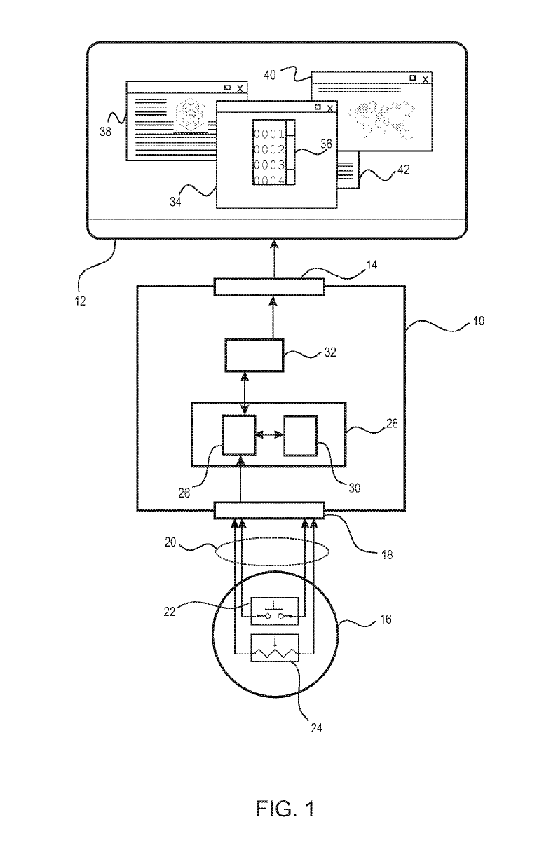

To more fully describe a particularly preferred embodiment of the system, reference is made to FIG. 1 which shows generally the system having a computer 10, with a screen 12 connected by way of interface 14. Also attached to the computer 10 is a separate hardware device 16 connected by way of interface 18, the connection being wired 20. For the purposes of clarity, the keyboard and mouse of the computer are not shown.

The hardware device 16 is dedicated to the function of the electronic recording of time. The device comprises a momentary switch 22 and a potentiometer 24. The switch and potentiometer are both connected to a disc (not shown) which allows user actuation and selection as described above. Output signals from the device 16 is transmitted to the computer 10 by way of interface 18 which in turn passes the signals to the operating system 26 which is held in random access memory 28. The operating system utilizes a purpose written driver (not shown) to decode the signals. The operating system passes the decoded signals to dedicated software 30, also held in random access memory 28. Dependant on the signals the dedicated software 30 sends instructions to the computer central processing unit 32 (via the operating system 26) to the screen 12 (via the interface 14).

The screen output shown in the drawing reflects the situation when the momentary switch 22 is actuated by the user. The actuation instantaneously brings to the central region and foreground of the screen a window 34 displaying a scrollable menu 36, the menu 36 having a list of matter identifiers (0001, 0002, 0003, 0004 . . . ). The scroll function of the menu 36 is operated by rotation of the potentiometer 24 clockwise and counter-clockwise as required. In the situation as drawn, the identifier “0001” is at the top of the menu box as is therefore in the position ready to be entered as the desired matter identifier. Actuation of the momentary switch 22 by the user causes entry of the identifier “0001” into the system, and time is accordingly recorded against that identifier.

Prior to user actuation of the momentary switch 22, the window 34 was minimised or was not fully visible due to overlay of windows 38, 40 and 42. The windows 38, 40 and 42 are windows opened by a user, and upon which the user is currently working. The windows 38, 40 and 42 may be a word processor window, a web browser window, or an email client window for example.

In an alternative form of the system, simply the rotation of potentiometer 24 by the user causes the window 34 to come to the foreground so as to allow the user to select a matter identifier from the menu 36.

Other types of hardware devices are contemplated to be useful, and given the benefit of the present specification the skilled person in enabled in identify other useful contrivances operable in the context of the present system. As one example only, the device may allow for selection of a matter directly from the device and without reference to any matter selection means. For example, the device may have a set number of possible matters from which to select from, such as a series of surfaces having indicia applied, each indicium indicative of a certain matter. The surface may be touched to acuate, or the device may be user-orientable such that the desired surface is facing upwardly. Selection of a matter in these ways nevertheless brings a window on a computer screen to the attention of the user, thereby allowing the user to confirm the matter, or select a sub-matter for example. Upon selection of a broad matter category (e.g. “reviewing documents”) the screen may allow the user to select a client (e.g. “ABC Inc”) from a scrollable menu of clients.

In another aspect the present invention comprises a kit of parts comprising a separate hardware device configured for operable connection to a computer, and also dedicated software (and optionally driver software) configured to operate in accordance with the system described herein. The software may or may not be physically embodied in the kit (for example, stored on optical media). In some embodiments, the kit comprises instructions for download of the software from a remote server. In yet other embodiments, the device is configured such that upon connection to a computer, the computer (which has been preconfigured) downloads the software automatically, or makes the software otherwise logically available to the device.

The system of the present invention may comprise further software configured to store, transform or otherwise manipulate the raw stored data. The raw stored data may comprise matter identifier, recorded time, date, user identification details, and the like. Such data may be used by an automatic billing software which automatically adds the recorded to an electronic invoice. Alternatively, the data may be used for the preparation of a report ascribing time spent on a certain matter by multiple employees, or time spent by a single employee over a number of matters.

The data output by the present systems may be used for comparative or benchmarking applications. For example, within an organization the output may be used by management to compare the amount of log timed by various workers in relation to various tasks. The benchmarked/comparative data output may be electronically displayed for review of all workers (optionally with data anonymized) so as to allow a single worker to assess his/her use of time against others in an organization.

Such analysis may not be limited to workers within an organization, and may extend to other cohorts. For example, a cohort of freelancers may transmit data output to a central server where it is transformed to comparative/benchmarked data and in turn published (optionally anonymized) for all participant freelancers to view.

Accordingly, in one embodiment the system comprises electronic means for receiving data output from a plurality of personnel in an organization and transforming the data into benchmarking or comparative data.

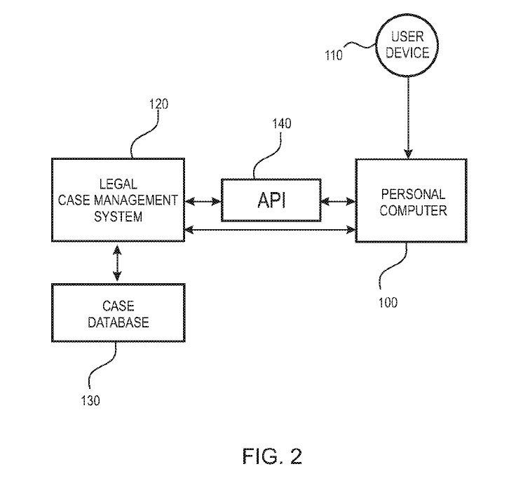

Reference is now made to FIG. 2 which demonstrates integration of a time recording and matter selection system comprising a personal computer 100 having a dedicated time recording and matter selection hardware device 110. The personal computer 100 is used by a staff member to access the case management system 120 of an employer legal firm. The case management system 120 has a database 130 storing details of all cases currently handled by the legal firm. The user interface of the personal computer comprises application software dedicated to (i) the selection of a matter and the recording of time and accepting inputs form the hardware device 110. The dedicated application software imports case details from the case database 130 via the case management system 120, and is configured to display details for each case on a menu presented on a user interface on the screen of personal computer 100. A case is selectable by the user from the menu by way of device 110. Time recording is started by user actuation of the device 110, and stopped by user actuation of the device 100. The elapsed time is calculated by the dedicated software of personal computer 100, and then transmitted with details of the selected case (for example, a case identification number) via API 140 to software of the legal case management system 120. Software of the legal cases management system 120 records the elapsed time against the selected case in case database 130.

The present invention has been described mainly by reference to operation in a professional services business seeking to improve time recordation for specific matter or clients. However the present invention is not so limited. The present systems, methods and kits will find utility in a broad range of commercial and non-commercial settings, including those described in the Background section herein. Given the benefit of the present specification the skilled person is enabled to conceive of any modification or variation to the embodiments as described herein. For example, more portable embodiments of the separate hardware device may be conceived for use with a smartphone or tablet, and therefore of greater suitability to recording use of private time away from the workplace. To that end, a smart watch may be utilised as separate hardware device. Some smart watches (such as the Samsung Gear™ range) are particularly suited given the presence of actuatable buttons (to start and cease timing) and rotatable bezel (for the selection of matter identifiers).

In the present systems, any of the computers may comprise network interface means configured to interface with other computer(s) of the system. The network interface means typically routes data into and out of the system computer. For example, the network interface may transmit a request to an information source computer to provide information on a given property, receive the requested information and then route that information to the system computer CPU (or a memory register accessible by the CPU).

The methods and systems described herein may be deployed in part or in whole through one or more computers that execute computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a coprocessor (math co-processor, graphic co-processor, communication co-processor and the like) and the like that may directly or indirectly facilitate execution of program code or program instructions stored thereon. In addition, the processor may enable execution of multiple programs, threads, and codes.

The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere.

The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through one or more computers that execute computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, computers, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, computers, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon.

Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on computer readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks. Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on computers through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such computers may include, but may not be limited to, personal digital assistants, laptops, personal computers, mobile phones, other handheld computing devices, wired or wireless communication devices, transducers, chips, calculators, satellites, tablet PCs, electronic books, gadgets, electronic devices, devices having artificial intelligence, computing devices, networking equipment, servers, routers and the like.

Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a computer readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The invention may be embodied in program instruction set executable on one or more computers. Such instructions sets may include any one or more of the following instruction types:

Data handling and memory operations, which may include an instruction to set a register to a fixed constant value, or copy data from a memory location to a register, or vice-versa (a machine instruction is often called move, however the term is misleading), to store the contents of a register, result of a computation, or to retrieve stored data to perform a computation on it later, or to read and write data from hardware devices.

Arithmetic and logic operations, which may include an instruction to add, subtract, multiply, or divide the values of two registers, placing the result in a register, possibly setting one or more condition codes in a status register, to perform bitwise operations, e.g., taking the conjunction and disjunction of corresponding bits in a pair of registers, taking the negation of each bit in a register, or to compare two values in registers (for example, to see if one is less, or if they are equal).

Control flow operations, which may include an instruction to branch to another location in the program and execute instructions there, conditionally branch to another location if a certain condition holds, indirectly branch to another location, or call another block of code, while saving the location of the next instruction as a point to return to.

Coprocessor instructions, which may include an instruction to load/store data to and from a coprocessor, or exchanging with CPU registers, or perform coprocessor operations.

A processor of a computer of the present system may include “complex” instructions in their instruction set. A single “complex” instruction does something that may take many instructions on other computers. Such instructions are typified by instructions that take multiple steps, control multiple functional units, or otherwise appear on a larger scale than the bulk of simple instructions implemented by the given processor. Some examples of “complex” instructions include: saving many registers on the stack at once, moving large blocks of memory, complicated integer and floating-point arithmetic (sine, cosine, square root, etc.), SIMD instructions, a single instruction performing an operation on many values in parallel, performing an atomic test-and-set instruction or other read-modify-write atomic instruction, and instructions that perform ALU operations with an operand from memory rather than a register.

An instruction may be defined according to its parts. According to more traditional architectures, an instruction includes an opcode that specifies the operation to perform, such as add contents of memory to register—and zero or more operand specifiers, which may specify registers, memory locations, or literal data. The operand specifiers may have addressing modes determining their meaning or may be in fixed fields. In very long instruction word (VLIW) architectures, which include many microcode architectures, multiple simultaneous opcodes and operands are specified in a single instruction.

Some types of instruction sets do not have an opcode field (such as Transport Triggered Architectures (TTA) or the Forth virtual machine), only operand(s). Other unusual “0-operand” instruction sets lack any operand specifier fields, such as some stack machines including NOSC.

Conditional instructions often have a predicate field—several bits that encode the specific condition to cause the operation to be performed rather than not performed. For example, a conditional branch instruction will be executed, and the branch taken, if the condition is true, so that execution proceeds to a different part of the program, and not executed, and the branch not taken, if the condition is false, so that execution continues sequentially. Some instruction sets also have conditional moves, so that the move will be executed, and the data stored in the target location, if the condition is true, and not executed, and the target location not modified, if the condition is false. Similarly, IBM z/Architecture has a conditional store. A few instruction sets include a predicate field in every instruction; this is called branch predication.

The instructions constituting a program are rarely specified using their internal, numeric form (machine code); they may be specified using an assembly language or, more typically, may be generated from programming languages by compilers.

The program may be embodied as computer-executable software written so as to be operable in the context of any computer, system or methods described herein. As indicated to supra, various components of the invention are provided as computer-executable software components. These components, and the functionality associated with each, may be used by client, server, or peer computer systems. These various components can be implemented into the system on an as-needed basis. These components may be written in an object-oriented computer language such that a component oriented or object-oriented programming technique can be implemented using a Visual Component Library (VCL), Component Library for Cross Platform (CLX), Java Beans (JB), Enterprise Java Beans (EJB), Component Object Model (COM), or Distributed Component Object Model (DCOM)), or other suitable technique. These components are linked to other components via various APIs and then compiled into one complete server and/or client application. The method for using components in the building of client and server applications is well known in the art. Further, these components may be linked together via various distributed programming protocols as distributed computing components.

Where the software may be embodied in the form of a “machine readable medium”. This term may be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies illustrated herein. The term “machine-readable medium” shall accordingly be taken to include, but not be limited to, solid-state memories, optical and magnetic media, and carrier wave signals.

While the invention has been disclosed in connection with the preferred embodiments shown and described in detail, various modifications and improvements thereon will become readily apparent to those skilled in the art.

Accordingly, the spirit and scope of the present invention is not to be limited by the foregoing examples, but is to be understood in the broadest sense allowable by law.

1.-20. (canceled)

21. A system for recording time, the system comprising:
a circular housing; and
an upward facing touch sensitive surface coupled to the circular housing;
the system configured to:
receive a first input at the upward facing touch sensitive surface, the first input being a rotation-type input to scroll through a proportion of a plurality of matter identifiers;
transmit the received first input to a processor-enabled device having an electronic memory storing the plurality of matter identifiers, wherein the processor-enabled device is configured to display at least the proportion of the stored plurality of matter identifiers on a visual display as a selectable menu, and upon receiving the first input, scroll the proportion of the stored plurality of matter identifiers;
receive a second input at the touch sensitive surface, the second input being a depression-type input corresponding to an actuation of time recording under a selected matter identifier;
transmit the received second input to the processor-enabled device to actuate time recording for the selected matter identifier and display on the visual display the selected matter identifier; and
receive, from the processor-enable device, a signal indicating the actuation of the time recording for the selected matter identifier, where a light within the circular housing is configured to provide a visual reminder of the actuation of the time recording for the selected matter identifier.

22. The system of claim 21, wherein one of the stored plurality of matter identifiers is a user-selectable menu, or a data entry window.

23. The system of claim 21, wherein the touch sensitive surface is operable by a rotation motion, a touching motion, or a sliding motion.

24. The system of claim 21, wherein the touch sensitive surface comprises a variable resistance component.

25. A method for recording time, the method comprising:
receiving an input at a touch sensitive surface, the input corresponding to at least an actuation of time recording or a selection of a matter identifier;
transmitting the received input to a processor-enabled device having an electronic memory storing a plurality of matter identifiers, wherein the processor-enabled device is configured to display at least a proportion of the stored plurality of matter identifiers on a visual display as a selectable menu, and upon receiving the input indicating the actuation of time recording for one of the plurality of matter identifier or the selection of the matter identifier of the plurality of matter identifier, the visual display displays for selection one of the stored plurality of matter identifiers, where the matter identifier is selectable;
receiving, from the processor-enable device, a signal indicating the actuation of the time recording or the selection of the matter identifier; and
in response to receiving the signal, actuating a light within the circular housing indicating the actuation.

26. The method of claim 23, wherein one of the stored plurality of matter identifiers is a user-selectable menu, or a data entry window.

27. The system of claim 23, wherein the touch sensitive surface is operable by a rotation motion, a touching motion, or a sliding motion.

28. The method of claim 23, wherein the touch sensitive surface comprises a variable resistance component.

29. An input device for recording time, the method comprising:
a circular housing;
a touch sensitive surface connected to the housing and configured to:
receive an input at the touch sensitive surface, the input corresponding to at least an actuation of time recording or a selection of a matter identifier;
transmit the received input to a processor-enabled device having an electronic memory storing a plurality of matter identifiers, wherein the processor-enabled device is configured to display at least a proportion of the stored plurality of matter identifiers on a visual display as a selectable menu, and upon receiving the input indicating the actuation of time recording for one of the plurality of matter identifier or the selection of the matter identifier of the plurality of matter identifier, the visual display displays for selection one of the stored plurality of matter identifiers, where the matter identifier is selectable;
receive, from the processor-enable device, a signal indicating the actuation of the time recording or the selection of the matter identifier; and
in response to receiving the signal, actuate a light within the circular housing indicating the actuation.

30. The device of claim 31, wherein one of the stored plurality of matter identifiers is a user-selectable menu, or a data entry window.

31. The device of claim 31, wherein the touch sensitive surface is operable by a rotation motion, a touching motion, or a sliding motion.

32. The device of claim 31, wherein the touch sensitive surface comprises a variable resistance component.
